(19) United States
(12) Patent Application Publication
(10) Pub. No.: US 2015/0135202 A1
(43) Pub. Date: May 14, 2015

(54) APPARATUS AND METHOD FOR PROVIDING CONTENT SERVICE, APPARATUS AND METHOD FOR PROVIDING SIBLING SERVICE, AND METHOD FOR DISPLAYING IMAGE

(71) Applicant: SAMSUNG ELECTRONICS CO., LTD., Suwon-si (KR)

(72) Inventors: Jong-il CHOI, Seoul (KR); Moon-su KIM, Suwon-si (KR); Seong-ho PARK, Bucheon-si (KR); Hee-dong PARK, Seoul (KR); Yun-sung HWANG, Seoul (KR)

(73) Assignee: SAMSUNG ELECTRONICS CO., LTD., Suwon-si (KR)

(21) Appl. No.: 14/323,043

(22) Filed: Jul. 3, 2014

(30) Foreign Application Priority Data
Nov. 8, 2013 (KR) 10-2013-0135640

(51) Int. Cl. H04N 21/475; H04N 21/4784; H04N 21/2543; H04N 7/173; H04N 7/16

(52) U.S. Cl. CPC H04N 21/4751; H04N 7/17309; H04N 7/165; H04N 21/2543; H04N 21/4784
USPC 725/5

(57) ABSTRACT

A content service providing apparatus includes: when an image display apparatus wishes to play or replay a content selected by a user, a communication interface configured to receive a request for replaying the content from the image display apparatus; an authority manager configured to identify details of an account for paying for the playing or replaying of the content based on the received request, and, when there is a shortfall in money for paying, to receive a confirmation on whether it is possible to make up for the shortfall from a sibling service providing apparatus, which gives an authority to play or replay the content regardless of the shortfall; and when it is possible to make up for the shortfall, a controller configured to control the communication interface to provide the content to the image display apparatus based on the authority.

### CROSS-REFERENCE TO RELATED APPLICATIONS

This application claims the benefit under 35 U.S.C. §119(a) of a Korean patent application filed on Nov. 8, 2013 in the Korean Intellectual Property Office and assigned Serial No. 10-2013-0135640, the entire disclosure of which is hereby incorporated by reference.

### BACKGROUND

1. Field

Apparatuses and methods consistent with exemplary embodiments relate to an apparatus and method for providing a content service, an apparatus and method for providing a sibling service, and a method for displaying an image, and more particularly, to an apparatus and method for providing a content service, an apparatus and method for providing a sibling service, and a method for displaying an image, in which, when a user wishes to replay a certain content through an image display apparatus like a television (TV), service providers subscribing to a sibling service make up for a shortfall in money needed to replay the content, so that the user can easily replay the content.

2. Description of the Related Art

As the Internet TVs have become increasingly popular, many users can purchase content that they desire by directly accessing service providers through the Internet, and can replay the purchased contents directly or at a predetermined later time. The users can purchase the content in various ways such as using their own mobile phones or credit cards, and can save up reward points by frequently using the service and can use those points (or mileage). Alternatively, the users can use the reward points saved up by using the mobile phones when purchasing content through the Internet TV. This can be achieved by an alliance between content service providers and communication operators.

However, the users may wish to use the points or other mileage information that have been obtained by using a specific paid service when using content of other service providers, but there are realistic limitations. Therefore, the users inevitably generate redundant accounts every time they use services in order to use content of other service providers and also register redundant purchase information. For example, a user generates an account at a server of a service provider A to purchase a paid content of a service A and registers payment information. Also, the user generates an account at a server of a service provider B to purchase a content of a service B and registers payment information.

As such, the user should generate an account and register payment information for each of the services in order to use services that do not have user's accounts and payment information integrated with one another, and should subscribe to an individual payment service to use a service of a different billing subject, which may cause inconvenience to the users

### SUMMARY

Additional aspects and/or advantages will be set forth in part in the description which follows and, in part, will be apparent from the description, or may be learned by practice of the embodiments.

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an apparatus and method for providing a content service, an apparatus and method for providing a sibling service, and a method for displaying an image, in which, when a user wishes to pay or replay a certain content through an image display apparatus like a TV, service providers subscribing to a sibling service make up for a shortfall in money that is needed to replay the content for the same user, so that the user can easily replay the content.

According to an aspect of an exemplary embodiment, there is provided a content service providing apparatus including: when an image display apparatus wishes to replay a content selected by a user, a communication interface configured to receive a request for replaying the content from the image display apparatus; an authority manager configured to identify details of an account for paying for the replaying of the content based on the received request, and, when there is a shortfall in money for paying, to receive a confirmation on whether it is possible to make up for the shortfall from a sibling service providing apparatus, which gives an authority to replay the content regardless of the shortfall; and, when it is possible to make up for the shortfall, a controller configured to control the communication interface to provide the content to the image display apparatus based on the authority which is given by the sibling service providing apparatus.

The content service providing apparatus may further include: an authenticator configured to perform authentication on at least one of the image display apparatus and the user of the image display apparatus; a payment details manager configured to manage the details of the account according to user's use of a service, to provide the details of the account to the image display apparatus according to a result of the authenticating, and to update the details of the account according to exercise of the authority; and an amount calculator configured to calculate an amount of the shortfall that is needed to purchase the content which is used by the exercise of the authority.

When the user is determined as a rightful member as a result of the authenticating, the authority manager may identify the details of the account.

The controller may provide a token through the communication interface in order for the sibling service providing apparatus to perform user authority management based on the token.

The controller may provide at least one of apparatus information of the image display apparatus and user information of the user to confirm the authority, in addition to the token.

The user information may include at least one of user's resident registration number, phone number, and a card number, which are provided when the user is authenticated.

According to an aspect of another exemplary embodiment, there is provided a sibling service providing apparatus including: when a first content service providing apparatus determines whether it is possible to purchase a content that a user wishes to replay through an image display apparatus, and there is a shortfall in money as a result of the determining, a communication interface configured to transmit a request for confirming whether it is possible to make up for the shortfall and receive a response to the request; a sibling service manager configured to confirm whether it is possible to make up for the shortfall in communication with a second content service providing apparatus, at which the image display apparatus is registered, according to the received request, and, when it is possible to make up for the shortfall, configured to give an authority to replay the content regardless of the shortfall; and a controller configured to control the communication interface to provide the given authority to the first content service providing apparatus as the response.

The communication interface may receive at least one of apparatus information of the image display apparatus and user information of the user from the first content service providing apparatus, and the sibling service manager may receive details of an account corresponding to user's use of a service from the second content service providing apparatus based on the received at least one information, and may identify the received details of the account, and when it is possible to make up for the shortfall as a result of the identifying, may give the authority.

The sibling service manager may notify that the second content service providing apparatus makes up for the shortfall, when giving the authority.

The sibling service manager may add up available points of the first content service providing apparatus and the second content service providing apparatus, and may determine whether it is possible to purchase the content according to a result of the adding up.

According to an aspect of still another exemplary embodiment, there is provided a method for providing a content service, the method including: when an image display apparatus wishes to replay a content selected by a user, receiving a request for replaying the content from the image display apparatus through a communication interface; identifying details of an account for paying for the replaying of the content based on the received request, and, when there is a shortfall in money for paying, receiving a confirmation on whether it is possible to make up for the shortfall from a sibling service providing apparatus, which gives an authority to replay the content regardless of the shortfall; and when it is possible to make up for the shortfall, controlling the communication interface to provide the content to the image display apparatus based on the authority which is given by the sibling service providing apparatus.

The method may further include: performing authentication on at least one of the image display apparatus and the user of the image display apparatus; managing the details of the account according to user's use of a service, providing the details of the account to the image display apparatus according to a result of the authenticating, and updating the details of the account according to exercise of the authority; and calculating an amount of the shortfall that is needed to purchase the content which is used by the exercise of the authority.

The confirming whether it is possible to make up for the shortfall may include, when the user is determined as a rightful member as a result of the authenticating, identifying the details of the account.

The controlling may include providing a token through the communication interface in order for the sibling service providing apparatus to perform user authority management based on the token.

The controlling may include providing at least one of apparatus information of the image display apparatus and user information of the user to confirm the authority, in addition to the token.

The user information may include at least one of user's resident registration number, phone number, and a card number, which are provided when the user is authenticated.

According to an aspect of still another exemplary embodiment, there is provided a method for providing a sibling service, the method including: when a first content service providing apparatus determines whether it is possible to purchase a content that a user wishes to replay through an image display apparatus, and there is a shortfall in money as a result of the determining, transmitting a request for confirming whether it is possible to make up for the shortfall and receiving a response to the request through a communication interface; confirming whether it is possible to make up for the shortfall in communication with a second content service providing apparatus, at which the image display apparatus is registered, according to the received request, and, when it is possible to make up for the shortfall, giving an authority to replay the content regardless of the shortfall; and controlling the communication interface to provide the given authority to the first content service providing apparatus as the response.

The communication interface may receive at least one of apparatus information of the image display apparatus and user information of the user from the first content service providing apparatus, and the giving the authority may include receiving details of an account corresponding to user's use of a service from the second content service providing apparatus based on the received at least one information, and identifying the received details of the account, and, when it is possible to make up for the shortfall as a result of the identifying, giving the authority.

The giving the authority may include notifying that the second content service providing apparatus makes up for the shortfall, when giving the authority.

The giving the authority may include adding up available points of the first content service providing apparatus and the second content service providing apparatus, and determining whether it is possible to purchase the content according to a result of the adding up.

According to an aspect of still another exemplary embodiment, there is provided a method for displaying an image including: receiving details of an account for paying for a content that a user wishes to replay and displaying the details of the account on a screen; where there is a shortfall in money for paying as a result of identifying the details of the account, displaying information for asking the user about whether to use a sibling service to replay the content regardless of the shortfall; when there is a request for using the sibling service, displaying information on whether it is possible to use the sibling service; and when it is possible to use the sibling service, receiving the content from a content service providing apparatus and replaying the content on the screen.

The sibling service may be a service that makes up for the shortfall using payable money of a different content service providing apparatus other than the content service providing apparatus at which the image display apparatus is registered.

According to an aspect of still another exemplary embodiment, there is provided a method including determining whether a first content service provider used to pay for a play of content to be received by a user has sufficient money to pay for the play of the content; requesting, by the user, a request for authorization for payment from a sibling service provider when the first content service provider does not have sufficient money; providing authority, by the sibling service provider, for the play of the content when payment is possible; playing the content to the user when the authority is received; and having a second content service provider make up for a shortfall based on the authority where the payment is in service points accumulated by the user using services of the first and second content service providers.

### BRIEF DESCRIPTION OF THE DRAWINGS

The above and/or other aspects will be more apparent by describing in detail exemplary embodiments, with reference to the accompanying drawings, in which:

FIG. 1 is a view illustrating a sibling service system according to an exemplary embodiment;

FIG. 2 is a block diagram illustrating a detailed configuration of a content service providing apparatus of FIG. 1;

FIGS. 3A and 3B are views to illustrate a data structure of an amount calculator of FIG. 2;

FIG. 4 is a block diagram illustrating a detailed configuration of a sibling service providing apparatus of FIG. 1;

FIG. 5 is a view to illustrate a process of replaying a content by using a sibling service according to an exemplary embodiment;

FIG. 6 is a flowchart illustrating a method for providing a content service according to an exemplary embodiment;

FIG. 7 is a flowchart illustrating a method for providing a sibling service according to an exemplary embodiment; and

FIG. 8 is a flowchart illustrating a method for displaying an image according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

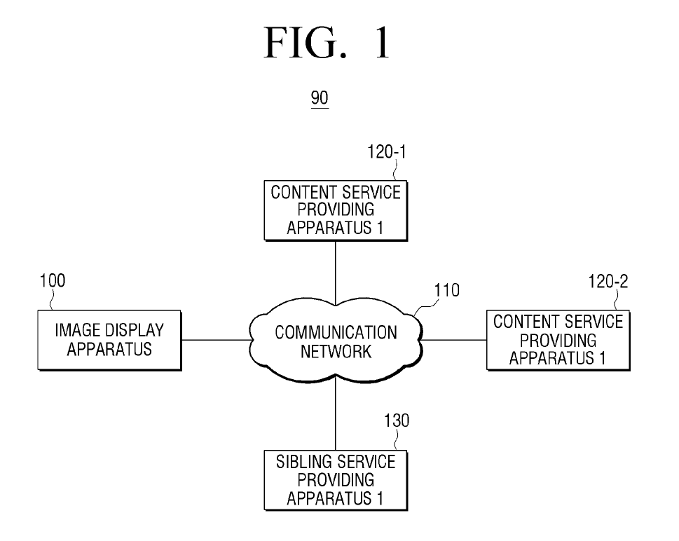

FIG. 1 is a view illustrating a sibling service system according to an exemplary embodiment.

As shown in FIG. 1, a sibling service system 90 according to an exemplary embodiment includes an image display apparatus 100, a communication network 110, a plurality of content service providing apparatuses 120_1 and 120_2, and a sibling service providing apparatus 130, and may further include an image relaying apparatus like a set-top box.

According to an exemplary embodiment, the image display apparatus 100 may be an image display apparatus of a touch screen type or may include a light emitting display apparatus like an organic light emitting diode (OLED) or a light receiving display apparatus like a liquid crystal display (LCD) apparatus. In addition, the image display apparatus 100 may be a display apparatus other than a television (TV), such as a computer or a mobile phone. The light receiving display apparatus includes a separate backlight unit to provide light. The backlight unit may include a light emitting diode (LED).

The image display apparatus 100 may receive various contents from the plurality of content service providing apparatuses 120_1 and 120_2 and may play or replay the contents. To achieve this, the user of the image display apparatus 100 may perform a separate subscribing procedure to purchase a content from one of the plurality of content service providing apparatuses 120_1 and 120_2, that is, may generate an account using user's name, resident registration number, phone number, etc., and also may register payment information to pay for the purchased content.

If the user of the image display apparatus 100 has completed the subscribing procedure to use services provided by a broadcast service provider, for example, a cable broadcast provider, at the time of purchasing the image display apparatus 100, the user may not perform the separate service subscribing procedure with the plurality of content service providing apparatuses 120_1 and 120_2. For example, if the cable broadcast provider allies to an enterprise operating the plurality of content service providing apparatuses 120_1 and 120_2, the user may use the services without performing the separate subscribing procedure. However, the user may be notified of this when using the service of the cable broadcast provider. After that, the user of the image display apparatus 100 may save up reward points by using the plurality of content service providing apparatuses 120_1 and 120_2 or using services of other allied enterprises.

The image display apparatus 100 can use a sibling service according to a contract between the plurality of content service providing apparatuses 120_1 and 120_2 (and their accounts) and the sibling service providing apparatus 130, that is, an alliance between them. The sibling service recited herein refers to a service that manages the plurality of content service providing apparatuses 120_1 and 120_2 as a sibling relationship so that the user can easily use services. For example, when the user wishes to use a specific service of the content service providing apparatus 1 120_1, the content service providing apparatus 2 120_2 and its account may support the purchase of the content, that is, may make up for a shortfall in money that is needed to purchase the content. Of course, this is possible only when the content service providing apparatus 2 120_2 can afford to make up for the shortfall. After that, the plurality of content service providing apparatuses 120_1 and 120_2 calculate (or process) the amount through a separate process.

More specifically, the image display apparatus 100 may try to receive information on the contents provided by the content service providing apparatus 1 120_1 and play or replay a content. When the user is determined as a rightful member by performing an authenticating process with the content service providing apparatus 1 120_1, the image display apparatus 100 may identify details of a user's account (or a payable breakdown) for paying for the content, for example, may identify whether there are saved-up points. When the user is an already subscribed member, the user may be determined as the rightful member based on apparatus information of the image display apparatus 100, which is provided at the time of requesting the replay or play of the content, without performing the separate authenticating process. When the user is the rightful member, the image display apparatus 100 may identify the details of the user's account for paying for the content. When it is not possible to pay for the content, the image display apparatus 100 may display information informing that it is possible to use the sibling service on the screen. When the user shows user's intention to use the sibling service, the image display apparatus 100 displays information on whether it is possible to use the sibling service on the screen again, and, when it is possible to play or replay the content by using the sibling service, the image display apparatus 100 receives the content from the content service providing apparatus 1 120_1 according to a user's replay or play request, and replays or plays the content. Detailed descriptions of this will be provided below.

The communication network 110 may include wired and wireless communication networks. The wired network includes a cable network or the Internet such as a Public Switched Telephone Network (PSTN), and the wireless network includes Code Division Multiple Access (CDMA), Wideband CDMA (WCDMA), Global System for Mobile Communications (GSM), Evolved Packet Core (EPC), Long Term Evolution (LTE), WiBro Network, etc. Accordingly, when the communication network 110 is a wired communication network, an access point can access a telephone exchange of a telephone office, but, when the communication network 110 is a wireless communication network, the access point may access a Serving GPRS Support Node (SGSN) or a Gateway GPRS Support Node (GGSN) which is operated by a telecommunication operator to process data, or may access various repeators such as Base Station Transmission (BTS), NodeB, e-NodeB, etc. to process data.

In addition, the communication network 110 may include a small base station (AP) such as a femto or pico base station, which is mainly installed in buildings. The femto and pico base stations are discriminated according to what is the maximum number of image display apparatuses that the base station can access. The AP includes a short-range communication module to communicate within a short range such as Zigbee and Wi-Fi. The short-range communication may be performed according to various standards such as Bluetooth, Zigbee, Infrared Data Association (IrDA), Radio Frequency (RF) such as Ultra High Frequency (UHF) and Very High Frequency (VHF), Ultra Wideband (UWB), etc, in addition to Wi-Fi. Accordingly, the AP extracts a location of a data packet, designates a best communication path for the extracted location, and transmits the data packet to a next apparatus, for example, the image display apparatus 100, through the designated communication path.

The content service providing apparatuses 1 120_1 and 2 120_2 may treat different kinds of image contents differently. For example, when the content service providing apparatus 1 120_1 is a server that is run by a broadcasting station and a cable broadcasting station providing broadcast signals, the content service providing apparatus 2 120_2 may be a server of a specific internal portal which subscribes to the sibling service along with the content service providing apparatus 1 120_1.

For example, when the image display apparatus 100 determines that there is a shortfall in the money for paying for a content that the user wishes to replay, the content service providing apparatus 1 120_1 provides at least one of apparatus information of the image display apparatus 100 and user information to the sibling service providing apparatus 130 and requests the sibling service. The content service providing apparatus 2 120_2 inquires whether there is information on the relevant apparatus or user based on the apparatus information or the user information provided by the content service providing apparatus 1 120_1 according to a request of the sibling service providing apparatus 130, and, when there is the relevant information, the content service providing apparatus 2 120_2 may provide the details of the user's account for paying afterward, that is, information on the saved-up points, to the sibling service providing apparatus 130.

Through the above-described process, the content service providing apparatus 2 120_2 can make up for the shortfall for the content service providing apparatus 1 120_1. Therefore, when the content service providing apparatus 1 120_1 is given the authority to replay or play the content by the sibling service providing apparatus 130, the content service providing apparatus 1 120_1 provides the content desired by the user to the image display apparatus 100 and then stores information on the given authority. After that, the content service providing apparatus 1 120_1 may calculate the amount for exercise of the authority with the content service providing apparatus 2 120_2.

The sibling service providing apparatus 130 manages the sibling service among the service providers which provide various contents. In other words, the sibling service providing apparatus 130 makes up for the shortfall in the money for replaying the content desired by the user among the plurality of content service providing apparatuses 120_1 and 120_2, thereby allowing the user replay or play the content easily. To achieve this, the sibling service providing apparatus 130 gives the plurality of content service providing apparatuses 120_1 and 120_2 the authority to use the sibling service. In other words, when the user of the image display apparatus 100 requests the sibling service, the sibling service providing apparatus 130 finds the user's points saved-up in the plurality of content service providing apparatuses 120_1 and 120_2 based on the apparatus information or user information, and provides the sibling service based on the points. For example, when it is possible to purchase the content requested by the user as a result of adding up the points, the sibling service providing apparatus 130 allows the content service providing apparatus to provide the content requested by the user.

According to the exemplary embodiment described above, when the user wishes to replay or play a content from among the contents provided by various service providers, the user is not required to register a user account and payment information for each of the service providers, one by one, and also, can easily purchase the desired content and thus can easily use the content.

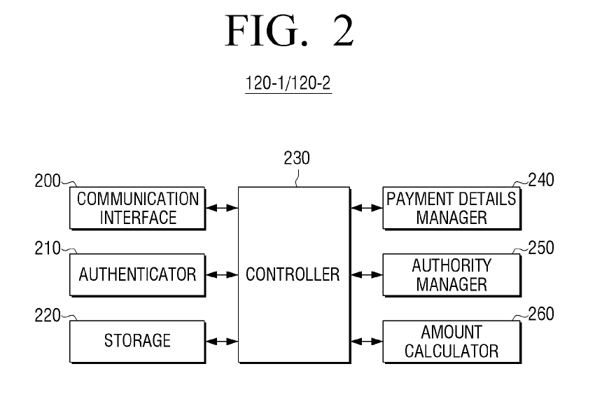

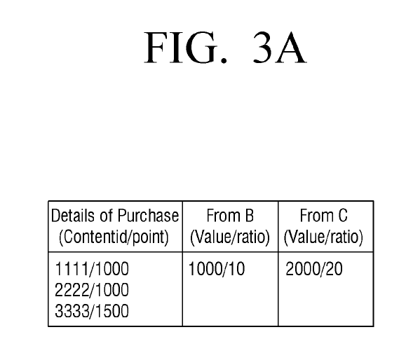

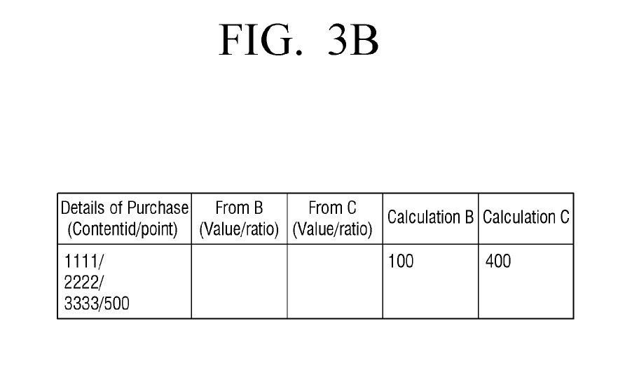

FIG. 2 is a block diagram illustrating a detailed configuration of a content service providing apparatus of FIG. 1, and FIGS. 3A and 3B are views to illustrate a data structure of an amount calculator of FIG. 2.

Referring to FIG. 2 along with FIG. 1, a content service providing apparatus 120_1 or 120_2 according to an exemplary embodiment includes some or all of a communication interface 200, an authenticator 210, a storage 220, a controller 230, a payment details manager 240, an authority manager 250, and an amount calculator 260.

The term “including some or all” implies that the authenticator 210 may structurally be omitted and may be incorporated into the sibling service providing apparatus 130 or an element like the payment details manager 240 may be incorporated into another element like the amount calculator 260. For the sake of easy understanding, the content service providing apparatus will be deemed to include all elements.

The communication interface 200 includes a communication module to communicate with the image display apparatus 100 and the sibling service providing apparatus 130. The communication interface 200 may transmit a content requested by the image display apparatus 100 and content-related data according to an operation of the communication module under the control of the controller 230. For example, when the user requests play or replay of a content, the content service providing apparatus 120_1 or 120_2 may provide the content and perform a payment process regarding the content. In the payment process, details of a user's account for paying, for example, information on saved-up points, may be provided. In addition, when there is a shortfall in the money or points for paying for the content that the user of the image display apparatus 100 wishes to replay, the communication interface 200 may transmit information on the shortfall or information asking about whether the user wishes to use a sibling service or not under the control of the controller 230. As such, the communication interface 200 may process a variety of data to provide the sibling service under the control of the controller 230.

The authenticator 210 may perform an authenticating process based on apparatus information which is transmitted when the user of the image display apparatus 100 wishes to play or replay a certain content. In addition, the authenticator 210 may request separate information, such as a resident registration number or a mobile phone number, from the user and may perform the authenticating process based on the separate information. When the user is determined as a rightful member or user, the authenticator 210 may transmit relevant information to the controller 230.

The storage 220 temporarily stores the various data processed in the content service providing apparatus 120_1 or 120_2 and outputs the data under the control of the controller 230. For example, when the user provides user information, the storage 220 receives the user information through the communication interface 200 and stores the user information under the control of the controller 230, and then may provide the user information to the authenticator 210. In addition, the storage 220 may store various contents to be provided to the users and may provide the contents at the request of the user.

The controller 230 controls overall operations of the communication interface 200, the authenticator 210, the storage 220, and the payment details manager 240, the authority manager 250, and the money calculator 260 in the content service providing apparatus 120_1 or 120_2. The controller 230 controls the authenticator 210 to perform the authentication in communication with the image display apparatus 100, and when the user is determined as the rightful member, the controller 230 controls the payment details manager 240 to provide the details of the user's account to the user. When there is a shortfall in the money for paying, the controller 230 controls the authority manager 250 to proceed with procedure for providing the sibling service along with the sibling service providing apparatus 130. After then, the controller 230 controls the amount calculator 260 to calculate the amount needed for the providing of the sibling service.

The payment details manager 240 manages the details of the accounts for the users using the content service. For example, the payment details manager 240 may manage details on items purchased by payment in the service or other own functions or corresponding points. For example, when the user saves up points as the user frequently uses the services, the payment details manager 240 manages the saved-up points, and, when the user saves up points corresponding to 10,000 won, the payment details manager 240 manages information regarding those points and provides the points when the user purchases a certain content to play or replay or at the request of the controller 230.

The authority manager 250 determines whether it is possible to use the content by comparing the remaining points of the details of the user's account and the amount due of the content. In addition, the authority manager 250 may respond to a service that is called for the authority. In other words, the authority manager 250 allows the user to use the content. Furthermore, the authority manager 250 may receive information of two parameters regarding content amount information and a payment ratio, and may monitor the authority management. For example, when there is a shortfall in the money for paying for the content that the user wishes to purchase, the authority manager 250 serves to provide the sibling service to the user in communication with the sibling service providing apparatus 130.

When a system Application Program Interface (API) is called to monitor service use authority of another service, the amount calculator 260 stores relevant data and retrieves the data. In other words, the amount calculator 260 may receive payment from a service that has requested payment, as much as a payment ratio of a content ID after the authority manger 250 approves the authority.

The amount calculator 260 may calculate the amount as shown in FIGS. 3A and 3B. For example, when parameters as many as 1000/10 are transmitted to the authority manager 250 from a service B, 1,000 won is deducted from the points that have been saved up as a service A has been used, (1000+1000+1500=3500), and 2500 points remain. After that, the amount calculator 260 may receive an authority approval commission as much as 1000*0.1=100 won from the service B according to the payment ratio.

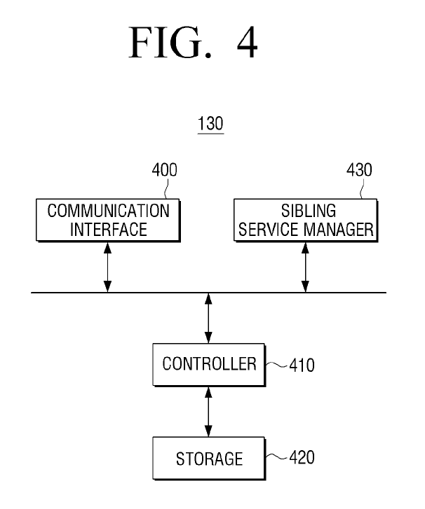

FIG. 4 is a block diagram illustrating a detailed configuration of the sibling service providing apparatus of FIG. 1.

Referring to FIG. 4 along with FIG. 1, the sibling service providing apparatus 130 according to an exemplary embodiment includes some or all of a communication interface 400, a controller 410, a storage 420, and a sibling service manager 430.

The term “including some or all” recited herein has the same meaning as mentioned above and the sibling service providing apparatus 130 is deemed to include all of the elements mentioned above for the sake of easy understanding.

The communication interface 400 includes a communication module to communicate with the content service providing apparatuses 120_1 and 120_2 of FIG. 1. For example, the communication interface 400 receives an inquiry about whether it is possible to provide a sibling service for the image display apparatus 100 or the user of the image display apparatus 100 from the content service providing apparatuses 120_1 and 120_2, and transmits the inquiry to the controller 410. The communication interface 400 may receive a response to the inquiry under the control of the controller 410 and may transmit the response to the content service providing apparatuses 120_1 and 120_2. As such, the communication interface 400 may exchange overall data that is processed in communication with the content service providing apparatuses 120_1 and 120_2 to provide the sibling service. For example, when receiving the inquiry about whether it is possible to provide the sibling service, the communication interface 400 may receive data regarding details of a specific user's account.

The controller 410 controls overall operations of the communication interface 400, the storage 420, and the sibling service manager 430 in the sibling service providing apparatus 130. For example, when the controller 410 receives an inquiry about whether it is possible to provide the sibling service for the image display apparatus 100 of a specific user from the content service providing apparatus 1 120_1, the controller 410 may provide apparatus information or user information that is received when receiving the inquiry to the content service providing apparatus 2 120_2 and may request the content service providing apparatus 2 120_2 to provide the details of the user's account. After that, the controller 410 may temporarily store the details of the user's account provided by the request in the storage 420, read out the details of the user's account, and provide the details of the user's account to the sibling service manager 430.

The controller 410 may control the communication interface 400 to transmit to the content service providing apparatus 1 120_1 the authority that the sibling service manger 430 gives or provides to indicate that it is possible to purchase and play/replay the content selected by the user even when there is a shortfall in the money for paying for the content. When information on the authority is provided, the controller 410 may transmit information on a payment ratio for the shortfall.

As mentioned above, the storage 420 may store the apparatus information that is provided when receiving the inquiry about whether it is possible to provide the sibling service for the image display apparatus 100 of the user from the content service providing apparatus 1 120_1, and may further store the user information, and may output the information to the sibling service manager 430 under the control of the controller 410. In addition, the storage 420 may temporarily store data on the details of the account of the same user, which is provided from the content service providing apparatus 2 120_2, and may provide the data to the sibling service manager 430.

The sibling service manager 430 determines whether the user who requested the sibling service has the authority to play/replay the content, and notifies a result of the determining. That is, when the user is determined as having the authority, the sibling service manager 430 may give or provide the user with the authority. For example, the sibling service manager 430 may be notified by the content service providing apparatus 1 120_1 that there is a request for the sibling service from a specific user. The sibling service manager 430 may know how much money is available in the user's account and how much money the user is short. This is because relevant information can be provided when the inquiry about whether it is possible to provide the sibling service to the specific user is received from the content service providing apparatus 1 120_1. After that, the sibling service manager 430 may request the content service providing apparatus 2 120_2, which subscribes to the sibling service, to provide the details of other accounts of the same user, if any. When the details of the other accounts of the same user are provided, the sibling service manager 430 compares the details of the accounts with the details of the account provided by the content service providing apparatus 1 120_1, and determines whether it is possible to make up for the shortfall. When it is possible to make up for the shortfall, the sibling service manager 430 may notify the user that the user has the authority to use the content. That is, the sibling service manager 430 allows the user to use the content. In addition, when giving the user the authority, the sibling service manager 430 provides information on the payment ratio to the plurality of content service providing apparatuses 120_1 and 120_2. Thereafter, the plurality of content service providing apparatuses 120_1 and 120_2 may calculate the amount based on the payment ratio.

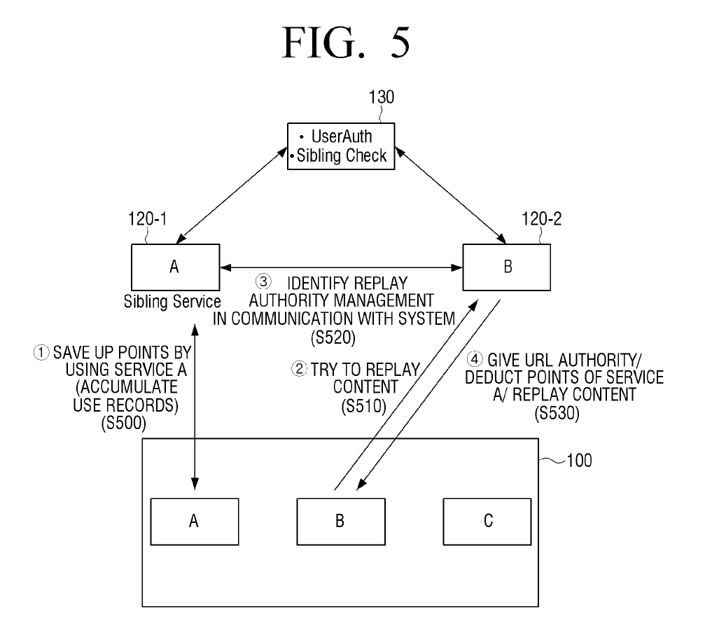

FIG. 5 is a view to illustrate a process of replaying a content by using a sibling service according to an exemplary embodiment.

Referring to FIG. 5 along with FIG. 1, the image display apparatus 100 according to an exemplary embodiment saves up points as the image display apparatus 100 frequently uses a service A of the content service providing apparatus 1 120_1 (S500). Of course, the user of the image display apparatus 100 may save up the points by using a service B of the content service providing apparatus 2 120_2.

After that, the image display apparatus 100 may try to replay or play a content that is provided by the content service providing apparatus 2 120_2 according to a user's request (S510).

When there is a shortfall in the money for the content, the image display apparatus 100 may make a request of the sibling service according to a user's request during this process.

Accordingly, the content service providing apparatus 2 120_2 confirms the authority regarding whether it is possible to play or replay the content in the image display apparatus 100 in communication with the sibling service providing apparatus 130 (S520).

When it is determined that the user has the authority for the content, the content service providing apparatus 2 120_2 gives the image display apparatus 100 the authority for the content and redeems (or deducts) the points related to the providing the authority afterward (S530).

When the authority is not provided to the image display apparatus 100 as a result of using the sibling service, the content service providing apparatus 2 120_2 may inform the user of this and may make the image display apparatus 100 use other paying methods, for example, paying a small sum of money via mobile phone or via using a credit card.

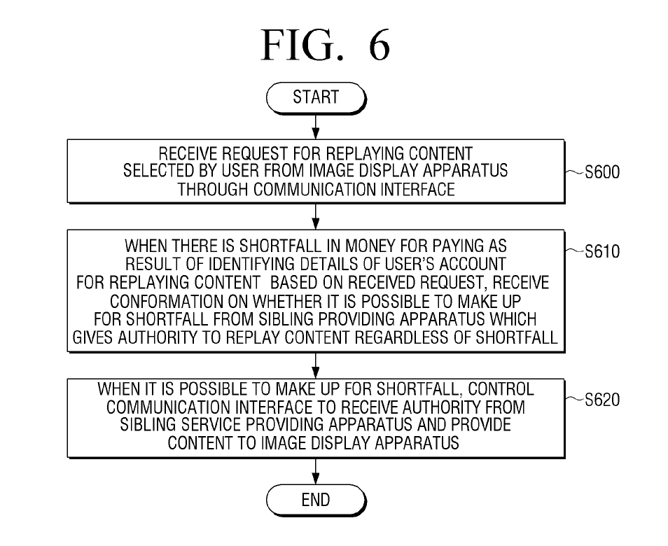

FIG. 6 is a flowchart illustrating a method for providing a content service according to an exemplary embodiment.

Referring to FIG. 6 along with FIG. 1, the content service providing apparatus 120_1 or 120_2 according to an exemplary embodiment receives a request for a content selected by a user from the image display apparatus 100 through the communication interface (S600). In this process, the content service providing apparatus 120_1 or 120_2 may identify apparatus information of the image display apparatus 100 and may simply determine whether the user is a rightful member subscribing to or authorized to subscribe to a service or not. Furthermore, the content service providing apparatus 120_1 and 120_2 may determine whether the user is the rightful member by requesting additional information from the user.

For example, when the user is the rightful member, the content service providing apparatus 120_1 or 120_2 identifies details of a user's account for playing the content based on the received request, and when there is a shortfall in money for paying, receives a confirmation on whether it is possible to make up for the shortfall, that is, whether it is possible to support the payment, from the sibling service providing apparatus 130, which gives the authority to play the content regardless of the shortfall in the money (S610).

When it is possible to make up for the shortfall, the content service providing apparatus 120_1 or 120_2 is provided the authority by the sibling service providing apparatus 130 and provides the content to the image display apparatus 100 (S620). To achieve this, the content service providing apparatus 120_1 or 120_2 controls the communication interface to inform the image display apparatus 100 of this according to the given authority or may directly provide the content requested.

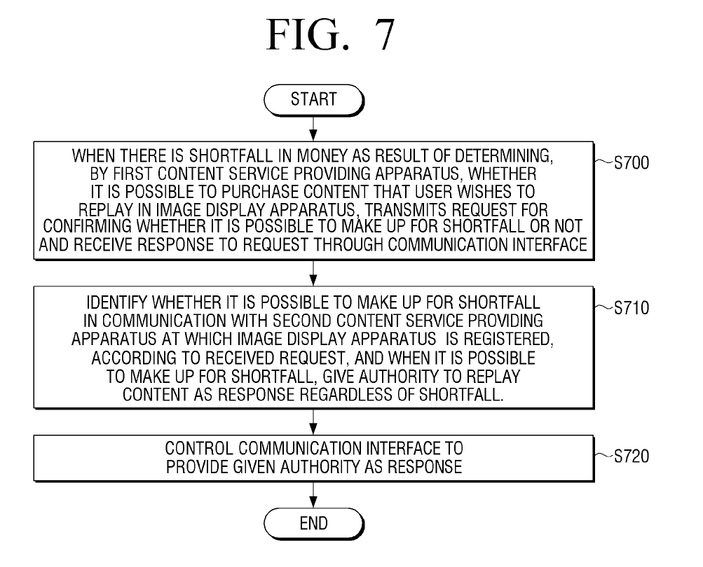

FIG. 7 is a flowchart illustrating a method for providing a sibling service according to an exemplary embodiment.

Referring to FIG. 7 along with FIG. 1 for convenience of explanation, as a result of determining, by the content service providing apparatus 1 120_1, whether it is possible to purchase a content that the user wishes to play or replay in the image display apparatus, when there is a shortfall in money, the sibling service providing apparatus 130 according to an exemplary embodiment transmits a request for confirming whether it is possible to make up for the shortfall or not and receives a response to the request through the communication interface (S700).

The sibling service providing apparatus 130 identifies whether it is possible to make up for the shortfall in communication with the content service providing apparatus 120_2, at which the image display apparatus 100 is registered, according to the received request, and when it is possible to make up for the shortfall, gives or provides the authority to replay or play the content as the response regardless of the shortfall (S710).

The sibling service providing apparatus 130 controls the communication interface to provide the authority as the response (S720).

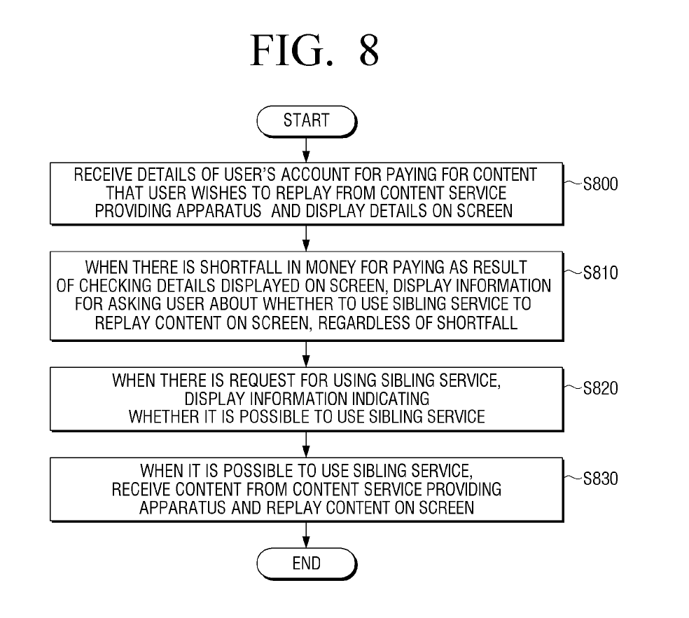

FIG. 8 is a flowchart illustrating a method for displaying an image according to an exemplary embodiment.

Referring to FIG. 8 along with FIG. 1 for convenience of explanation, the image display apparatus 100 according to an exemplary embodiment receives details of a user's account for paying for a content that the user wishes to play or replay from the content service providing apparatus 120_1 or 120_2 and displays the details on a screen (S800).

When there is a shortfall in money for paying as a result of checking the details displayed on the screen, the image display apparatus 100 displays information asking a user about whether to use a sibling service to replay the content on the screen, regardless of the shortfall (S810).

For example, when the user requests the sibling service, the image display apparatus 100 may inform the user of a result of the request of the sibling service (S820).

When it is possible to use the sibling service as a result of determining whether it is possible to do so, the image display apparatus 100 receives the content from the content service providing apparatus 120_1 or 120_2 according to the user request and may play the content on the screen (S830).

Although it is explained that all elements of the exemplary embodiments are combined into a single element or operate in combination with one another, the present disclosure is not limited to those exemplary embodiments. That is, one or more elements may be selectively combined and operate only if they belong to the scope of the present disclosure. In addition, although each of the elements may be implemented as a single independent computer type hardware component, some or all of the elements may be selectively combined and may be implemented as a computer program having a program module for performing some or all of functions combined in one or a plurality of hardware components. Codes and code segments constituting the computer program can be easily inferred by an ordinary skilled person in the related art. Such a computer program may be stored in a non-transitory computer readable medium, and may be read and executed by a computer, so that the exemplary embodiments can be implemented.

The non-transitory computer readable medium refers to a medium that stores data semi-permanently rather than storing data for a very short time, such as a register, a cache, and a memory, and is readable by an apparatus. Specifically, the above-described programs may be stored in a non-transitory computer readable medium such as a compact disc (CD), a digital versatile disk (DVD), a hard disk, a Blu-ray disk, a universal serial bus (USB), a memory card, and a read only memory (ROM), and may be provided.

The foregoing exemplary embodiments and advantages are merely exemplary and are not to be construed as limiting the embodiment concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A content service providing apparatus, comprising:
a communication interface configured to receive a request for replaying content from an image display apparatus when the image display apparatus wishes to replay the content as selected by a user;
an authority manager configured to identify details of an account for paying for the replaying of the content based on the request, and, when there is a shortfall in money for paying, to receive a confirmation on whether a possibility exists to make up for the shortfall from a sibling service providing apparatus, which provides an authority to replay the content regardless of the shortfall; and
a controller configured to control the communication interface to provide the content to the image display apparatus based on the authority provided by the sibling service providing apparatus when make up for the shortfall is possible.

2. The content service providing apparatus of claim 1, further comprising:
an authenticator configured to perform authentication on at least one of the image display apparatus and the user of the image display apparatus;
a payment details manager configured to manage the details of the account according to a user's use of a service, to provide the details of the account to the image display apparatus according to a result of the authentication, and to update the details of the account according to exercise of the authority; and
an amount calculator configured to calculate an amount of the shortfall needed to purchase the content which is used by the exercise of the authority.

3. The content service providing apparatus of claim 2, wherein, when the user is determined as a rightful member as a result of the authentication, the authority manager identifies the details of the account.

4. The content service providing apparatus of claim 1, wherein the controller provides a token through the communication interface for the sibling service providing apparatus to perform user authority management based on the token.

5. The content service providing apparatus of claim 4, wherein the controller provides at least one of apparatus information of the image display apparatus and user information of the user to confirm the authority, in addition to the token.

6. The content service providing apparatus of claim 5, wherein the user information comprises at least one of user's resident registration number, phone number, and a card number, which are provided when authentication of the user occurs.

7. A sibling service providing apparatus, comprising:
a communication interface configured to transmit a request for confirming whether a possibility exists to make up a shortfall in money and receive a response to a request when a first content service providing apparatus determines whether a possibility exists to purchase a content that a user wishes to replay through an image display apparatus, and there is the shortfall in money;
a sibling service manager configured to confirm whether the possibility exists to make up for the shortfall in communication with a second content service providing apparatus, at which the image display apparatus is registered, according to the request, and, when the possibility exists to make up for the shortfall, configured to provide an authority to replay the content regardless of the shortfall; and
a controller configured to control the communication interface to provide the authority to the first content service providing apparatus as the response.

8. The sibling service providing apparatus of claim 7, wherein the communication interface receives at least one of apparatus information of the image display apparatus and user information of the user from the first content service providing apparatus, and
wherein the sibling service manager receives details of an account corresponding to a user's use of a service from the second content service providing apparatus based on the received at least one information, and identifies the details of the account, and when the possibility exists to make up for the shortfall as a result of identifying, provides the authority.

9. The sibling service providing apparatus of claim 8, wherein the sibling service manager notifies that the second content service providing apparatus is making up for the shortfall, when providing the authority.

10. The sibling service providing apparatus of claim 8, wherein the sibling service manager adds up available points of the first content service providing apparatus and the second content service providing apparatus, and determines whether a possibility exists to purchase the content according to a result of the adds up.

11. A method for providing a content service, the method comprising:
when an image display apparatus wishes to replay a content selected by a user, receiving a request for replaying the content from the image display apparatus through a communication interface;
identifying details of an account for paying for the replaying of the content based on the request, and, when there is a shortfall in money for paying, receiving a confirmation on whether a possibility exists to make up for the shortfall from a sibling service providing apparatus, which provides an authority to replay the content regardless of the shortfall; and
when the possibility exists to make up for the shortfall, controlling the communication interface to provide the content to the image display apparatus based on the authority which is provided by the sibling service providing apparatus.

12. The method of claim 11, further comprising:
performing authentication on at least one of the image display apparatus and the user of the image display apparatus;
managing the details of the account according to a user's use of a service, providing the details of the account to the image display apparatus according to a result of the authentication, and updating the details of the account according to exercise of the authority; and
calculating an amount of the shortfall needed to purchase the content which is used by the exercise of the authority.

13. The method of claim 12, wherein the confirming whether the possibility exists to make up for the shortfall comprises, when the user is determined as a rightful member as a result of the authentication, identifying the details of the account.

14. The method of claim 11, wherein the controlling comprises providing a token through the communication interface for the sibling service providing apparatus to perform user authority management based on the token.

15. The method of claim 14, wherein the controlling comprises providing at least one of apparatus information of the image display apparatus and user information of the user to confirm the authority, in addition to the token.

16. The method of claim 15, wherein the user information comprises at least one of user's resident registration number, phone number, and a card number, which are provided when authentication of the user occurs.

17. A method for providing a sibling service, the method comprising:
when a first content service providing apparatus determines whether a possibility exists to purchase a content that a user wishes to replay through an image display apparatus, and there is a shortfall in money as a result, transmitting a request for confirming whether it is possible to make up for the shortfall and receiving a response to the request through a communication interface;
confirming whether it the possibility exists to make up for the shortfall in communication with a second content service providing apparatus, at which the image display apparatus is registered, according to the request, and, when the possibility exists to make up for the shortfall, providing an authority to replay the content regardless of the shortfall; and
controlling the communication interface to provide the authority to the first content service providing apparatus as the response.

18. The method of claim 17, wherein the communication interface receives at least one of apparatus information of the image display apparatus and user information of the user from the first content service providing apparatus, and
wherein the providing the authority comprises receiving details of an account corresponding to a user's use of a service from the second content service providing apparatus based on the at least one information, and identifying the received details of the account, and, when it the possibility exists to make up for the shortfall as a result of the identifying, providing the authority.

19. The method of claim 18, wherein the providing the authority comprises notifying that the second content service providing apparatus is making up for the shortfall, when providing the authority.

20. The method of claim 18, wherein the providing the authority comprises adding up available points of the first content service providing apparatus and the second content service providing apparatus, and determining whether it is possible to purchase the content according to a result of the adding up.

21. A method for displaying an image, comprising:
receiving details of an account for paying for a content that a user wishes to replay and displaying the details of the account on a screen;
where there is a shortfall in money for paying as a result of identifying the details of the account, displaying information for asking the user about whether to use a sibling service to replay the content regardless of the shortfall;
when there is a request for using the sibling service, displaying information on whether a possibility exists to use the sibling service; and
when the possibility exists to use the sibling service, receiving the content from a content service providing apparatus and replaying the content on the screen.

22. The method of claim 21, wherein the sibling service is a service that makes up for the shortfall using payable money of a different content service providing apparatus other than the content service providing apparatus at which the image display apparatus is registered.
